(19) United States
(12) Patent Application Publication
(10) Pub. No.: US 2025/0379345 A1
(43) Pub. Date: Dec. 11, 2025

(54) SECONDARY BATTERY AND METHOD FOR MANUFACTURING SAME

(71) Applicant: SAMSUNG SDI CO., LTD., Yongin-Si (KR)

(72) Inventor: Junho BYEON, Yongin-Si (KR)

(21) Appl. No.: 18/945,192

(22) Filed: Nov. 12, 2024

(30) Foreign Application Priority Data
Jun. 10, 2024 (KR) 10-2024-0075332

(51) Int. Cl. H01M 50/586; H01M 50/103; H01M 50/533; H01M 50/595; H01M 50/636

(52) U.S. Cl. CPC H01M 50/586; H01M 50/103; H01M 50/533; H01M 50/595; H01M 50/636

(57) ABSTRACT

A secondary battery includes: an electrode assembly including an electrode stack including a first electrode, a separator, and a second electrode; a first electrode tab and a second electrode tab protruding from a top surface of the electrode stack; a first insulating member attached to the top surface of the electrode stack, a first surface of the first electrode tab, and a first surface of the second electrode tab; a second insulating member attached to a rear surface of the electrode stack, a second surface of the first electrode tab, and a second surface of the second electrode tab; a case having one opened surface, and to accommodate the electrode assembly; and a case cover to cover the opened surface of the case to seal the electrode assembly from the outside.

### CROSS-REFERENCE TO RELATED APPLICATION

The present application claims priority to and the benefit of Korean Patent Application No. 10-2024-0075332, filed on Jun. 10, 2024, in the Korean Intellectual Property Office, the entire disclosure of which is incorporated by reference herein.

### BACKGROUND

### 1. Field

Aspects of embodiments of the present disclosure relate to a secondary battery, and a method for manufacturing the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Generally, the electrode tab of the electrode assembly is connected to the electrode terminal in the case, and the electrode assembly is accommodated in the case. An insulating plate is provided between the electrode tab and the case, so as to prevent a short circuit therebetween.

The above information disclosed in this Background section is for enhancement of understanding of the background of the present disclosure, and therefore, it may contain information that does not constitute related (or prior) art.

### SUMMARY

Embodiments of the present disclosure may be directed to a secondary battery and a method for manufacturing the secondary battery, in which a short circuit between an electrode tab and a case may be prevented, and the capacity of the secondary battery may be improved.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to one or more embodiments of the present disclosure, a secondary battery includes: an electrode assembly including an electrode stack including a first electrode, a separator, and a second electrode, and a first electrode tab and a second electrode tab protruding from a top surface of the electrode stack; a first insulating member attached to the top surface of the electrode stack, a first surface of the first electrode tab, and a first surface of the second electrode tab; a second insulating member attached to a rear surface of the electrode stack, a second surface of the first electrode tab, and a second surface of the second electrode tab; a case having one opened surface, and configured to accommodate the electrode assembly; and a case cover configured to cover the opened surface of the case to seal the electrode assembly from the outside.

In an embodiment, each of the first electrode tab and the second electrode tab may include: a first bent portion located in proximity to the top surface of the electrode stack; and a first extension portion extending from the first bent portion.

In an embodiment, the first insulating member may be located between the top surface of the electrode stack and the first extension portion of the first electrode tab, and between the top surface of the electrode stack and the first extension portion of the second electrode tab.

In an embodiment, each of the first electrode tab and the second electrode tab may include: a second extension portion extending from the first extension portion; and a second bent portion located between the first extension portion and the second extension portion.

In an embodiment, the second insulating member may be located between the case and the rear surface of the electrode stack, between the first extension portion of the first electrode tab and the second extension portion of the first electrode tab, and between the first extension portion of the second electrode tab and the second extension portion of the second electrode tab.

In an embodiment, the first insulating member may be configured to insulate between the top surface of the electrode stack and one surface of the first electrode tab, and between the top surface of the electrode stack and one surface of the second electrode tab. The second insulating member may be configured to insulate between the case and the rear surface of the electrode stack, between the case and another surface of the first electrode tab, and between the case and another surface of the second electrode tab.

In an embodiment, each of the first insulating member and the second insulating member may be continuously attached to cover the first electrode tab and the second electrode tab while extending in a direction from the first electrode tab to the second electrode tab on the top surface of the electrode stack.

In an embodiment, the secondary battery may further include: a first electrode terminal penetrating through the case, and connected to the first electrode tab; and a second electrode terminal spaced from the first electrode terminal, penetrating through the case, and connected to the second electrode tab.

In an embodiment, each of the first insulating member and the second insulating member may include an electrolyte injection port.

In an embodiment, the secondary battery may further include a sealing member configured to seal the electrolyte injection port.

In an embodiment, each of the first insulating member and the second insulating member may include an insulating tape.

In an embodiment, each of the first insulating member and the second insulating member may include at least one of polyethylene terephthalate (PET), polypropylene (PP), or polyether ether ketone (PEEK).

According to one or more embodiments of the present disclosure, a method of manufacturing a secondary battery, includes: forming an electrode assembly including an electrode stack including a first electrode, a separator, and a second electrode; protruding a first electrode tab and a second electrode tab from a top surface of the electrode stack; attaching a first insulating member to the top surface of the electrode stack, one surface of the first electrode tab, and one surface of the second electrode tab; attaching a second insulating member to a rear surface of the electrode stack, another surface of the first electrode tab, and another surface of the second electrode tab; accommodating the electrode assembly in a case having one opened surface, while bending the first electrode tab and the second electrode tab; and covering the opened surface of the case with a case cover to seal the electrode assembly from the outside.

In an embodiment, the accommodating of the electrode assembly may include: firstly bending the first electrode tab and the second electrode tab downward in proximity to the top surface of the electrode stack; secondly bending the first electrode tab and the second electrode tab upward to be connected to a first electrode terminal and a second electrode terminal formed to penetrate through the case; connecting the first electrode tab and the second electrode tab to the first electrode terminal and the second electrode terminal, respectively; and thirdly bending the first electrode tab and the second electrode tab to accommodate the electrode assembly in the case.

In an embodiment, the firstly bending may include: forming a first bending portion in each of the first electrode tab and the second electrode tab in proximity to the top surface of the electrode stack; and disposing the first insulating member between the top surface of the electrode stack and a first extension portion extending from the first bending portion of each of the first electrode tab and the second electrode tab.

In an embodiment, the secondly bending may include forming a second bent portion in each of the first electrode tab and the second electrode tab by bending the first electrode tab and the second electrode tab upward at one end where the first insulating member and the second insulating member are attached to the first electrode tab and the second electrode tab.

In an embodiment, the thirdly bending may include disposing a second insulating member between a first extension portion extending from a first bent portion formed by firstly bending each of the first electrode tab and the second electrode tab and a second extension portion extending from a second bent portion formed by secondly bending each of the first electrode tab and the second electrode tab.

In an embodiment, the thirdly bending may further include aligning the first electrode tab and the second electrode tab, so that the second bent portion of each of the first electrode tab and the second electrode tab is fixed by using a bending guide.

In an embodiment, the attaching of the first insulating member and the second insulating member may include continuously attaching each of the first insulating member and the second insulating member to cover the first electrode tab and the second electrode tab in a direction from the first electrode tab to the second electrode tab on the top surface of the electrode stack.

In an embodiment, the method may further include: forming an electrolyte injection port in each of the first insulating member and the second insulating member; injecting an electrolyte into the electrolyte injection port; and sealing the electrolyte injection port with a sealing member.

According to some embodiments of the present disclosure, by disposing the insulating member, a short circuit may be prevented from occurring between the electrode stack and the electrode tab, and between the electrode tab and the case.

According to some embodiments of the present disclosure, because the insulating plate may not be included in the case, a wider electrode assembly accommodation space may be secured within the case.

However, the aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a cross-sectional view of a secondary battery according to some embodiments of the present disclosure.

FIG. 2 illustrates a cross-sectional view taken along the line A-A in FIG. 1.

FIG. 3 illustrates a cross-sectional view taken along the line B-B in FIG. 1.

FIGS. 4-13 illustrate views of a method for manufacturing a secondary battery according to some embodiments of the present disclosure.

FIG. 14 illustrates a flowchart of a method for manufacturing a secondary battery according to some embodiments of the present disclosure.

FIG. 15 illustrates a flowchart of a method for accommodating an electrode assembly in a case according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components ”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

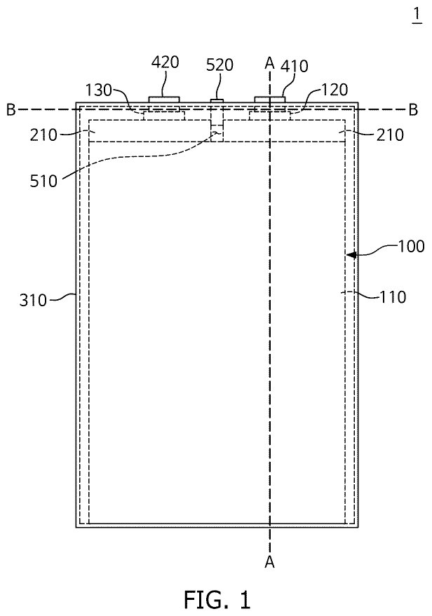

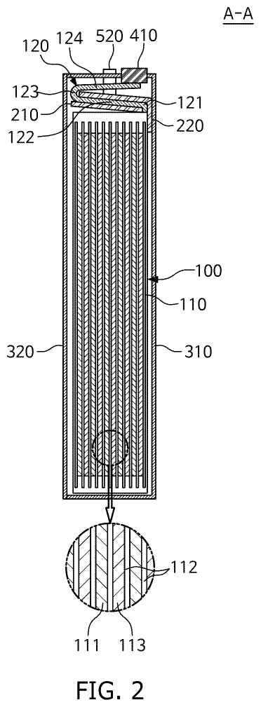

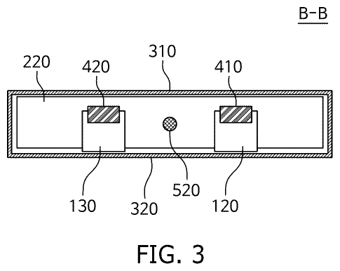

FIG. 1 illustrates a cross-sectional view of a secondary battery according to some embodiments of the present disclosure. FIG. 2 illustrates a cross-sectional view taken along the line A-A in FIG. 1. FIG. 3 illustrates a cross-sectional view taken along the line B-B in FIG. 1.

Referring to FIGS. 1 to 3, a secondary battery 1 according to some embodiments of the present disclosure may include an electrode assembly 100, a first insulating member 210, a second insulating member 220, a case 310, and a case cover 320. The electrode assembly 100 may include an electrode stack 110, a first electrode tab 120, and a second electrode tab 130.

According to some embodiments, the electrode stack 110 may include a first electrode 111, a separator 112, and a second electrode 113. The electrode stack 110 may be formed by winding or stacking a stack of the first electrode 111, the separator 112, and the second electrode 113, which may be formed in a thin plate or film shape. In a case where the electrode stack 110 is a wound stack, the winding axis may be parallel to or substantially parallel to the vertical axis direction of the case 310. In addition, the electrode stack 110 may be a stack kind rather than a wound kind. However, the shape of the electrode stack 110 is not particularly limited.

According to some embodiments, the electrode stack 110 may be a Z-stack electrode stack 110 in which a positive electrode plate and a negative electrode plate are inserted onto opposite sides of the separator 112 that is bent in a Z-stack. In addition, the electrode stack 110 may be stored inside the case 310 by stacking one or more electrode stacks 110, so that the long sides thereof are adjacent to each other. However, the number of electrode stacks 110 is not particularly limited. In the electrode stack 110, the first electrode 111 may serve as a negative electrode and the second electrode 113 may serve as a positive electrode. In other embodiments, the first electrode 111 may serve as the positive electrode and the second electrode 113 may serve as the negative electrode.

The first electrode 111 may be formed by applying an active material, such as graphite or carbon, to a current collector plate formed of a metal foil, such as copper, a copper alloy, nickel, or a nickel alloy. The first electrode 111 may include a first uncoated portion, which is a region where the active material is not applied. The first uncoated portion may be connected to the first electrode tab 120 that is separately formed, or a portion of the first uncoated portion may be punched out to form the first electrode tab 120.

The second electrode 113 may be formed by applying an active material, such as a transition metal oxide, to a current collector plate formed of a metal foil, such as aluminum or an aluminum alloy. The second electrode 113 may include a second uncoated portion, which is a region where the active material is not applied. The second uncoated portion may be connected to the second electrode tab 130 that is separately formed, or a portion of the second uncoated portion may be punched out to form the second electrode tab 130.

However, the present disclosure is not particularly limited to the structure of the electrode stack 110 described above.

According to one embodiment, the first electrode 111 may be a negative electrode. The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

According to one embodiment, the second electrode 113 may be a positive electrode. The positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c<0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The first electrode tab 120 and the second electrode tab 130 may have a symmetrical or substantially symmetrical structure with each other. Hereinafter, the first electrode tab 120 will be described in more detail with reference to FIG. 2, and redundant description as applicable to the second electrode tab 130 may not be repeated.

According to some embodiments, the first electrode tab 120 may be formed to protrude from the top surface of the electrode stack 110. For example, the first electrode tab 120 may be formed to protrude from a rear end region of the top surface of the electrode stack 110. The first electrode tab 120 may serve as a path for a current flow between the first electrode plate and the first current collector. In some embodiments, the first electrode tab 120 may be formed by cutting the first electrode plate to protrude toward one side in advance of manufacturing the first electrode plate, and may further protrude toward one side than the separator 112 without a separate cutting.

According to some embodiments, the first electrode tab 120 may be connected to a first electrode terminal 410. The first electrode tab 120 may be bent and connected to the first electrode terminal 410. The first electrode 111 may be electrically connected to the first electrode terminal 410 through the first electrode tab 120.

According to some embodiments, the first insulating member 210 may be attached to one surface of the first electrode tab 120, and the second insulating member 220 may be attached to another surface of the first electrode tab 120.

According to some embodiments, the first electrode tab 120 may protrude from the rear end region of the top surface of the electrode stack 110, may be firstly bent in a front end direction of the top surface, and may be secondly bent in a rear end direction of the top surface. The front end direction of the top surface refers to a direction of one surface where the first insulating member 210 is attached to the first electrode tab 120, and the rear end direction of the top surface refers to a direction of another surface (e.g., an opposite surface) where the second insulating member 220 is attached to the first electrode tab 120.

According to some embodiments, the first electrode tab 120 may include a first bent portion 121, a first extension portion 122, a second bent portion 123, and a second extension portion 124. The first bent portion 121 may be formed in proximity to the top surface of the electrode stack 110. The first bent portion 121 may be formed in a region where the first electrode tab 120 is in proximity to the top surface of the electrode stack 110, and is firstly bent in the front end direction of the top surface. The first extension portion 122 may extend from the first bent portion 121. The first extension portion 122 may extend from the first bent portion 121 in the front end direction of the top surface. The second bent portion 123 may be formed in a region where the first electrode tab 120 is secondly bent in the rear end direction of the top surface. The second extension portion 124 may extend from the second bent portion 123. The second extension portion 124 may extend from the second bent portion 123 in the rear end direction.

According to some embodiments, the first insulating member 210 may be disposed between the first extension portion 122 of the first bent portion 121 and the top surface of the electrode stack 110. The second insulating member 220 may be disposed between the first extension portion 122 of the first bent portion 121 and the second extension portion 124 of the first bent portion 121. The other surface of the second extension portion 124 that does not face the first extension portion 122 may be connected to the first electrode terminal 410.

According to some embodiments, the second electrode tab 130 may be formed to protrude from the top surface of the electrode stack 110. The second electrode tab 130 may serve as a path for a current flow between the second electrode plate and the second current collector. In some examples, the second electrode tab 130 may be formed by cutting the second electrode plate to protrude toward the other side in advance of manufacturing the second electrode plate, and may further protrude toward the other side than the separator 112 without a separate cutting. The second electrode tab 130 may be spaced apart from the first electrode tab 120 on the top surface of the electrode stack 110.

According to some embodiments, the first insulating member 210 may be attached to one surface of the second electrode tab 130, and the second insulating member 220 may be attached to the other surface of the second electrode tab 130.

According to some embodiments, the second electrode tab 130 may protrude from the rear end region of the top surface of the electrode stack 110, may be firstly bent in the front end direction of the top surface, and may be secondly bent in the rear end direction of the top surface.

According to some embodiments, the second electrode tab 130 may include a first bent portion, a first extension portion, a second bent portion, and a second extension portion. As described above, because the configurations of the second electrode tab 130 may be symmetrical or substantially symmetrical with the configurations of the first electrode tab 120 described above, and thus, may have the same or substantially the same structure as each other, redundant description thereof will not be repeated.

According to some embodiments, the first insulating member 210 may be attached to the top surface of the electrode stack 110, one surface of the first electrode tab 120, and one surface of the second electrode tab 130.

According to some embodiments, the first electrode tab 120 and the second electrode tab 130 may be firstly bent, so that the first insulating member 210 may be disposed between the top surface of the electrode stack 110 and the first extension portion 122 of the first electrode tab 120 and between the top surface of the electrode stack 110 and the first extension portion of the second electrode tab 130.

According to some embodiments, in a case where the first electrode tab 120 and the second electrode tab 130 are firstly bent, the first insulating member 210 may insulate between the top surface of the electrode stack 110 and the first extension portion 122 of the first electrode tab 120 and between the top surface of the electrode stack 110 and the first extension portion of the second electrode tab 130. Because the secondary battery 1 according to some embodiments of the present disclosure includes the first insulating member 210, it may be possible to prevent a short circuit that may be caused due to a contact between the first electrode tab 120 and the second electrode tab 130.

According to some embodiments, the second insulating member 220 may be attached to the rear surface of the electrode stack 110, the other surface of the first electrode tab 120, and the other surface of the second electrode tab 130.

According to some embodiments, the first electrode tab 120 and the second electrode tab 130 may be secondly bent, so that the second insulating member 220 may be disposed between the case 310 and the rear surface of the electrode stack 110, between the first extension portion 122 of the first electrode tab 120 and the second extension portion 124 of the first electrode tab 120, and between the first extension portion of the second electrode tab 130 and the second extension portion of the second electrode tab 130.

According to some embodiments, in a case where the first electrode tab 120 and the second electrode tab 130 are secondly bent, the second insulating member 220 may insulate between the case 310 and the rear surface of the electrode stack 110, between the first extension portion 122 of the first electrode tab 120 and the second extension portion 124 of the first electrode tab 120, and between the first extension portion of the second electrode tab 130 and the second extension portion of the second electrode tab 130. Because the secondary battery 1 according to some embodiments of the present disclosure includes the second insulating member 220, it may be possible to prevent a short circuit that may be caused due to the overlap of the first electrode tab 120 and the second electrode tab 130, or due to a contact of the first electrode tab 120 and the second electrode tab 130 with the case 310.

According to some embodiments, the first insulating member 210 and the second insulating member 220 may each be continuously attached to cover the first electrode tab 120 and the second electrode tab 130 in the direction of the first electrode tab 120 and the second electrode tab 130 on the top surface of the electrode stack 110. The first insulating member 210 and the second insulating member 220 may each be continuously attached from one end to the other end of the top surface of the electrode stack 110 in the direction from the first electrode tab 120 to the second electrode tab 130 on the top surface of the electrode stack 110. The first insulating member 210 and the second insulating member 220 may be formed to be longer along the left and right widths of the electrode stack 110, so as to cover the entire top surface of the electrode stack 110. Accordingly, even in a case where the first electrode tab 120 and the second electrode tab 130 are moved or bent, it may be possible to prevent a short circuit with the electrode stack 110 or the case 310.

According to some embodiments, each of the first insulating member 210 and the second insulating member 220 may be an insulating tape, but the present disclosure is not limited thereto. Each of the first insulating member 210 and the second insulating member 220 may have an adhesive layer having one surface on which an adhesive is applied. The first insulating member 210 and the second insulating member 220 may be attached on the electrode stack 110 while facing one surface to which the adhesive is applied, with the first electrode tab 120 and the second electrode tab 130 therebetween.

According to some embodiments, the first insulating member 210 and the second insulating member 220 may include at least one of polyethylene terephthalate (PET), polypropylene (PP), or polyether ether ketone (PEEK), but the present disclosure is not limited thereto.

According to some embodiments, each of the first insulating member 210 and the second insulating member 220 may include an electrolyte injection port 510. The electrolyte injection port 510 may be formed in the first insulating member 210 and the second insulating member 220 through a punching process. In a case where the electrode assembly 100 is accommodated in the case 310, the electrolyte injection port 510 formed in each of the first insulating member 210 and the second insulating member 220 may be disposed at a position corresponding to the electrolyte injection port 510 provided in the case 310.

According to some embodiments, the case 310 may form the overall appearance of the secondary battery 1. The case 140 may be formed of stainless steel (SUS). In other embodiments, the case 310 may be formed of a conductive metal, such as aluminum, an aluminum alloy, or a nickel-plated steel.

According to some embodiments, one side of the case 310 may be opened to accommodate the electrode assembly 100. The first electrode terminal 410 and the second electrode terminal 420 may be formed to penetrate through the top surface of the case 310 corresponding to the top surface of the electrode assembly 100. In addition, the electrolyte injection port 510 may be formed in the top surface of the case 310. The electrolyte injection port 510 formed in the top surface of the case 310 may be disposed at a position corresponding to the electrolyte injection port 510 formed in each of the first insulating member 210 and the second insulating member 220.

According to some embodiments, the case cover 320 may cover the opened surface of the case 310, and seal the electrode assembly 100 from the outside. The case cover 320 may cover the opened surface of the case 310 after the electrode assembly 100 is accommodated in the case 310. For example, the case cover 320 may be welded along the circumference of the opened surface of the case 310, but the present disclosure is not limited thereto.

According to some embodiments, the first electrode terminal 410 may be formed to penetrate through the case 310. The first electrode terminal 410 may be formed separately from the case 310, or may be formed integrally with the case 310. The first electrode terminal 410 may be connected to the first electrode tab 120. The first electrode terminal 410 may be electrically connected to the first electrode 111 through the first electrode tab 120.

According to some embodiments, the second electrode terminal 420 may be spaced apart from the first electrode terminal 410, and may be formed to penetrate through the case 310. The second electrode terminal 420 may be formed separately from the case 310, or may be formed integrally with the case 310. The second electrode terminal 420 may be connected to the second electrode tab 130. The second electrode terminal 420 may be electrically connected to the second electrode 113 through the second electrode tab 130.

According to some embodiments, the electrolyte injection port 510 may be formed in the first insulating member 210 and the second insulating member 220. In addition, in a case where the electrode assembly 100 is accommodated in the case 310, the electrolyte injection port 510 may be formed in one surface of the case corresponding to the position where the first insulating member 210 and the second insulating member 220 are disposed. After the electrolyte is injected through the electrolyte injection port 510, a sealing member 520 may seal the electrolyte injection port 510. The sealing member 520 may be a sealing pin, but the present disclosure is not limited thereto.

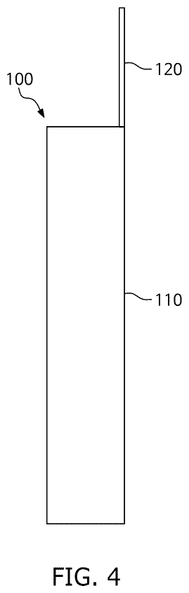

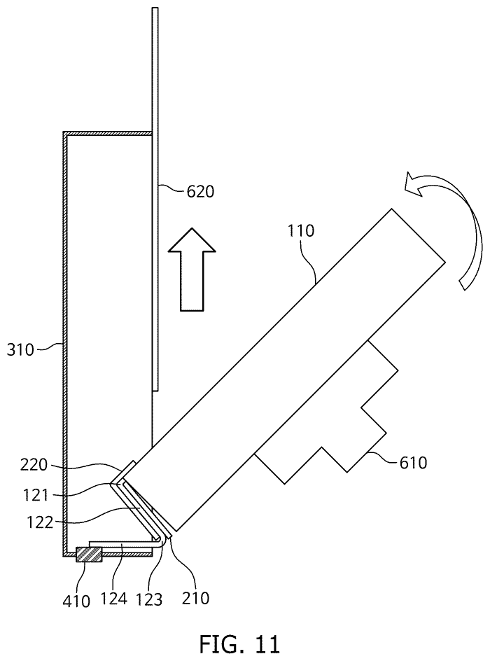

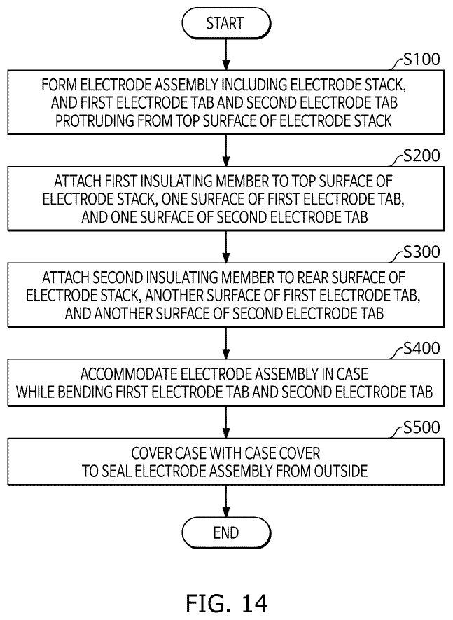

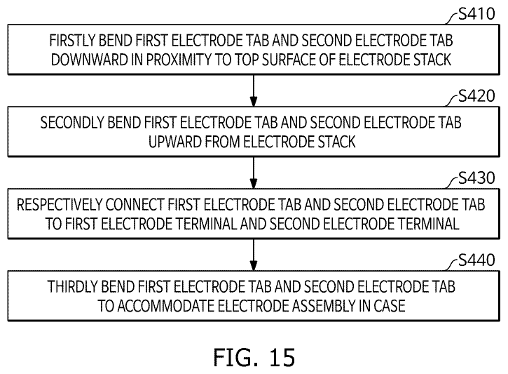

FIGS. 4 through 13 illustrate views of a method for manufacturing a secondary battery according to some embodiments of the present disclosure. FIG. 14 illustrates a flowchart of a method for manufacturing a secondary battery according to some embodiments of the present disclosure. FIG. 15 illustrates a flowchart of a method for accommodating an electrode assembly in a case according to some embodiments of the present disclosure.

Hereinafter, various processes of the method of manufacturing the secondary battery 1 according to some embodiments of the present disclosure will be described in more detail with reference to FIGS. 4 to 15. Because the first electrode tab 120 and the second electrode tab 130 may be symmetrical or substantially symmetrical with each other, they may have the same or substantially the same structure as each other. Accordingly, hereinafter, the right cross-sectional view of the secondary battery 1 illustrating the first electrode tab 120 will be described in more detail, and redundant description with respect to the second electrode tab 130 may not be repeated.

Referring to FIG. 14, an electrode assembly 100 may be formed to include an electrode stack 110, and a first electrode tab 120 and a second electrode tab 130 protruding from the top surface of the electrode stack 110 (S100).

Referring to FIG. 4, the electrode stack 110 may include a first electrode 111, a separator 112, and a second electrode 113 (e.g., see FIG. 2). The electrode stack 110 may be formed by winding or stacking a stack of the first electrode 111, the separator 112, and the second electrode 113, which may be formed in a thin plate or film shape. In the electrode stack 110, the first electrode 111 may serve as a negative electrode and the second electrode 113 may serve as a positive electrode, but the present disclosure is not limited thereto.

According to other embodiments, the first electrode tab 120 and the second electrode tab 130 may be formed to protrude from the top surface of the electrode stack 110. The first electrode tab 120 and the second electrode tab 130 may be formed to protrude from the rear end region of the top surface of the electrode stack 110. The first electrode tab 120 and the second electrode tab 130 may be formed by cutting a first electrode plate and a second electrode plate to protrude toward one side in advance of manufacturing the first electrode plate and the second electrode plate, and may further protrude toward one side than the separator 112 without a separate cutting.

Referring to FIG. 14, a first insulating member 210 may be attached to the top surface of the electrode stack 110, one surface of the first electrode tab 120, and one surface of the second electrode tab 130 (S200). A second insulating member 220 may be attached to the rear surface of the electrode stack 110, the other surface of the first electrode tab 120, and the other surface of the second electrode tab 130 (S300).

The attaching of the first insulating member 210 and the second insulating member 220 (e.g., at S200 and S300) may include continuously attaching the first insulating member 210 and the second insulating member 220 to cover the first electrode tab 120 and the second electrode tab 130 in a direction of the first electrode tab 120 and the second electrode tab 130 on the top surface of the electrode stack 110.

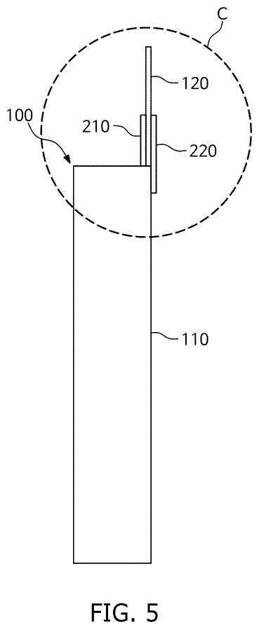

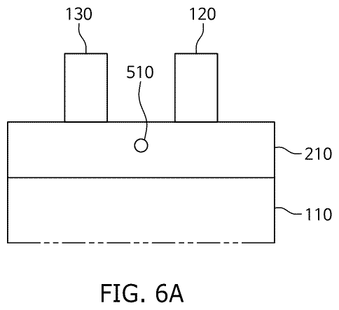

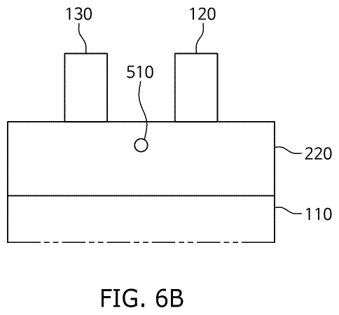

Referring to FIGS. 5 to 6B, the first insulating member 210 and the second insulating member 220 may be continuously attached from one end to the other end of the top surface of the electrode stack 110 in the direction from the first electrode tab 120 to the second electrode tab 130 on the top surface of the electrode stack 110. Each of the first insulating member 210 and the second insulating member 220 may be attached to cover the entire top surface of the electrode stack 110, Accordingly, even in a case where the first electrode tab 120 and the second electrode tab 130 are moved or bent, it may be possible to prevent a short circuit that may be caused with the electrode stack 110 or the case 310.

According to other embodiments, each of the first insulating member 210 and the second insulating member 220 may be an insulating tape, but the present disclosure is not limited thereto. Each of the first insulating member 210 and the second insulating member 220 may have an adhesive layer having one surface on which an adhesive is applied. The first insulating member 210 and the second insulating member 220 may be attached on the electrode stack 110 while facing the one surface to which the adhesive is applied, with the first electrode tab 120 and the second electrode tab 130 therebetween.

According to other embodiments, the first insulating member 210 and the second insulating member 220 may include at least one of PET, PP, or PEEK, but the present disclosure is not limited thereto.

The attaching of the first insulating member 210 and the second insulating member 220 (e.g., at S200 and S300) may further include forming an electrolyte injection port 510 in the first insulating member 210 and the second insulating member 220. For example, the electrolyte injection port 510 may be formed in the first insulating member 210 and the second insulating member 220 through a punching process. The position where the electrolyte injection port 510 is formed in the first insulating member 210 and the second insulating member 220 may be a position where the electrode assembly 100 is accommodated in the case 310 and which corresponds to the electrolyte injection port 510 formed in the case 310.

Referring to FIG. 14, the electrode assembly 100 may be accommodated in the case 310 while bending the first electrode tab 120 and the second electrode tab 130 (S400). For example, the electrode assembly 100 may be accommodated in the case 310 through the one opened surface, while the first electrode tab 120 and the second electrode tab 130 are bent. Referring to FIG. 15, the first electrode tab 120 and the second electrode tab 130 may be firstly bent downward in proximity to the top surface of the electrode stack 110 (S410). The first electrode tab 120 and the second electrode tab 130 may be secondly bent upward from the electrode stack 110 (S420).

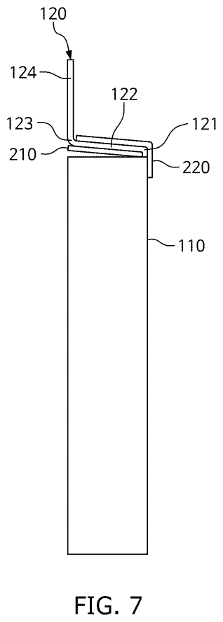

Referring to FIG. 7, the first electrode tab 120 may include a first bent portion 121, a first extension portion 122, a second bent portion 123, and a second extension portion 124. The first electrode tab 120 may protrude from the rear end region of the top surface of the electrode stack 110, and may be firstly bent in the front end direction of the top surface. The first bent portion 121 may be formed in a region where the first electrode tab 120 is in proximity to the top surface of the electrode stack 110, and is firstly bent in the front end direction of the top surface. The first extension portion 122 may extend from the first bent portion 121. The first extension portion 122 may extend from the first bent portion 121 in the front end direction of the top surface.

According to other embodiments, the first electrode tab 120 may be secondly bent upward so as to be connected to the first electrode terminal 410 formed to penetrate through the case 310 at one end where the first insulating member 210 and the second insulating member 220 are attached. The second bent portion 123 may be formed in a region that is secondly bent at one end where the first insulating member 210 and the second insulating member 220 are attached. The second extension portion 124 may extend from the second bent portion 123. The second extension portion 124 may be connected to the first electrode terminal 410. The second bent portion 123 may be firstly bent so that the second extension portion 124 extends from the electrode stack 110 in the vertical direction. As described in more detail below, the second bent portion 123 may be secondly bent so that the electrode assembly 100 may be accommodated in the case 310 (e.g., S440 of FIG. 15).

According to other embodiments, as the first electrode tab 120 is firstly bent, the first insulating member 210 may be disposed between the first extension portion 122 of the first bent portion 121 and the top surface of the electrode stack 110, and the second insulating member 220 may be disposed to face the first insulating member 210 with the first extension portion 122 therebetween.

In other words, the firstly bending may be performed in the region where the first bent portion 121 is formed, so as to insulate between the first electrode tab 120 and the electrode stack 110. The secondly bending may be firstly performed in the region where the second bent portion 123 is formed, so as to facilitate a connection between the first electrode tab 120 and the first electrode terminal 410. Thirdly bending may be secondly performed in the region where the second bent portion 123 is formed, so that the electrode assembly 100 is accommodated in the case 310.

Because the second electrode tab 130 may be symmetrical or substantially symmetrical the first electrode tab 120 described above, and thus, they may have the same or substantially the same structure as each other, redundant description thereof may not be repeated.

Referring to FIG. 15, the first electrode tab 120 and the second electrode tab 130 may be respectively connected to the first electrode terminal 410 and the second electrode terminal 420 (S430).

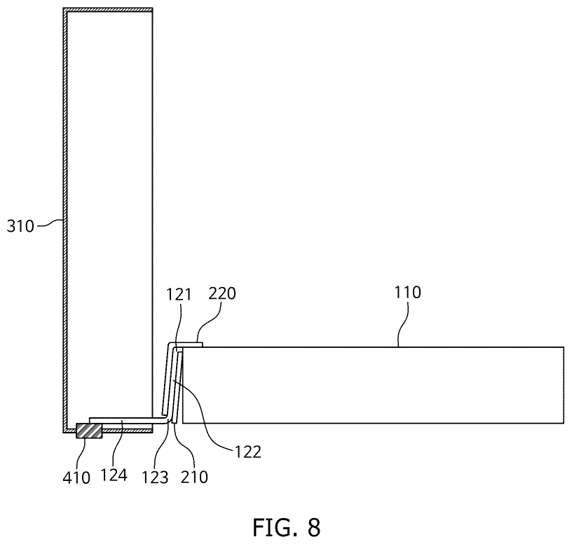

Referring to FIG. 8, the first electrode terminal 410 may be formed to penetrate through the case 310. The first electrode terminal 410 may be formed separately from the case 310, or may be formed integrally with the case 310. In the process of connecting the first electrode tab 120 and the first electrode terminal 410 to each other, the case 310 may be disposed so that the first electrode terminal 410 is located below the case 310, and the electrode assembly 100 may be disposed perpendicular to or substantially perpendicular to the case 310, so as to minimize or reduce a movement or a bending of the first electrode tab 120 due to gravity and the like.

According to other embodiments, the first electrode tab 120 may be connected to a first electrode terminal 410. One surface of the second extension portion 124 of the first electrode tab 120 may be connected to the first electrode terminal 410. The first electrode terminal 410 may be electrically connected to the first electrode 111 of the electrode assembly 100 through the first electrode tab 120.

Referring to FIG. 15, the first electrode tab 120 and the second electrode tab 130 may be thirdly bent so that the electrode assembly 100 is accommodated in the case 310 (S440).

The thirdly bent (e.g., in S440) may further include aligning the first electrode tab 120 and the second electrode tab 130, so that the second bent portions 123 of the first electrode tab 120 and the second electrode tab 130 are fixed by using a bending guide 620.

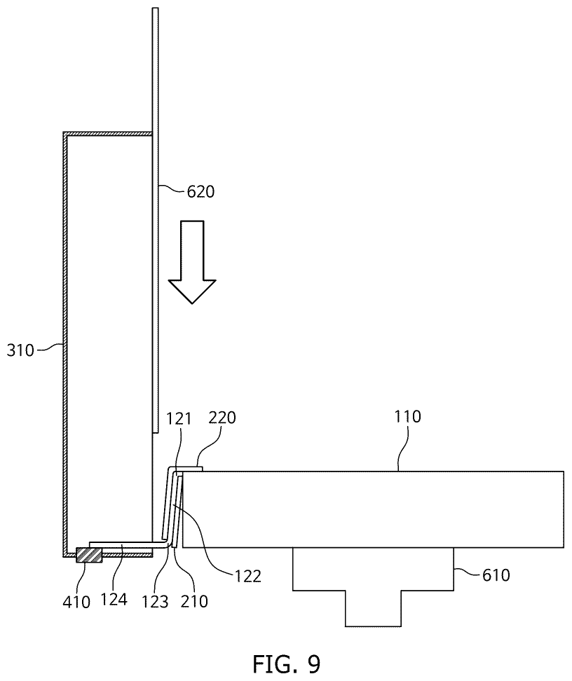

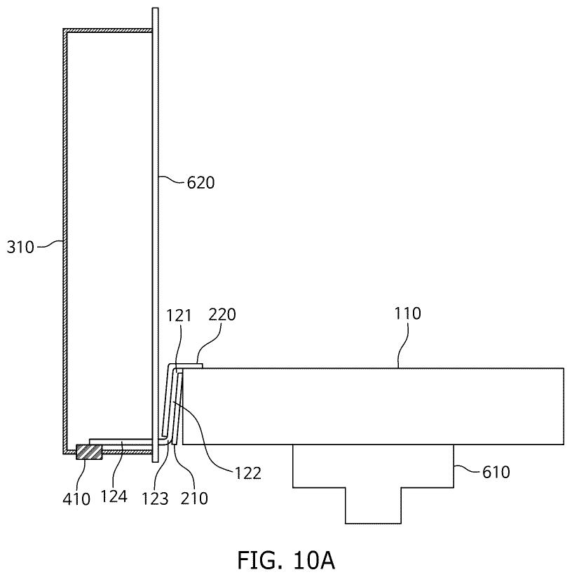

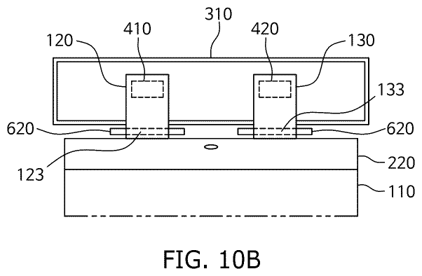

Referring to FIGS. 9 to 10B, the electrode assembly 100 may be disposed on a bending pusher 610. The bending pusher 610 may be a device that may accommodate the electrode assembly 100 in the case 310 with a constant or substantially constant motion line. For example, the bending pusher 610 may accommodate the electrode assembly 100 in the case 310 by rotating the electrode assembly 100 in a constant or substantially constant motion line with respect to the second bent portion 123.

According to other embodiments, the bending guide 620 may be disposed on one opened surface of the case 310. The bending guide 620 may be a device for aligning the first electrode tab 120 and the second electrode tab 130, so that the second bent portion 1230 of the first electrode tab 120 and the second bent portion of the second electrode tab 130 are fixed in the thirdly bending (e.g., S440). For example, after the first electrode tab 120 and the second electrode tab 130 are aligned by disposing the bending guide 620 on the left and right sides of the second bent portion 123 of the first electrode tab 120 and the second bent portion of the second electrode tab 130, the electrode assembly 100 may be accommodated in the case 310 while bending the first electrode tab 120 and the second electrode tab 130.

The thirdly bent (e.g., in S440) may include disposing the second insulating member 220 between the first extension portion 122 extending from the first bent portion 121 formed by firstly bending the first electrode tab 120 and the second electrode tab 130 and the second extension portion 124 extending from the second bent portion 123 formed by secondly bending the first electrode tab 120 and the second electrode tab 130.

According to other embodiments, as described above, in a case where the first electrode tab 120 is thirdly bent, the second bent portion 123 may be secondly bent in the direction of the electrode stack 110. The second bent portion 123 is secondly bent, so that the second extension portion 124 faces the first extension portion 122. The second insulating member 220 may be disposed between the first extension portion 122 and the second extension portion 124. The second insulating member 220 may insulate between the case 310 and the rear surface of the electrode stack 110 and between the first extension portion 122 and the second extension portion 124 of the first electrode tab 120. In other words, in a case where the first electrode tab 120 and the second electrode tab 130 are thirdly bent while the electrode assembly 100 is accommodated in the case 310, the second insulating member 220 may be disposed to prevent a short circuit from occurring due to the overlap of the first electrode tab 120 and the second electrode tab 130, or due to a contact of the first electrode tab 120 and the second electrode tab 130 with the case 310.

Referring to FIG. 14, the case cover 320 may cover the opened surface of the case 310 to seal the electrode assembly 100 from the outside (S500).

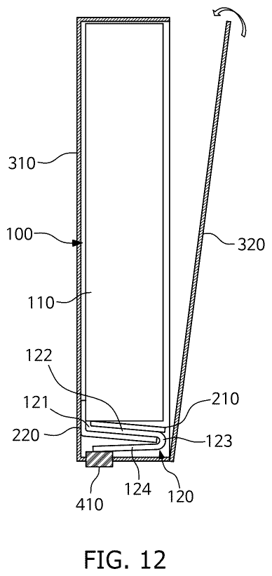

Referring to FIG. 12, the case cover 320 may cover the opened surface of the case 310 to seal the electrode assembly 100 from the outside. The case cover 320 may cover the opened surface of the case 310 after the electrode assembly 100 is accommodated in the case 310. For example, the case cover 320 may be welded along the circumference of the opened surface of the case 310, but the present disclosure is not limited thereto.

The covering of the case (e.g., S500) may further include injecting an electrolyte into the electrolyte injection port 510, and sealing the electrolyte injection port 510 with a sealing member 520.

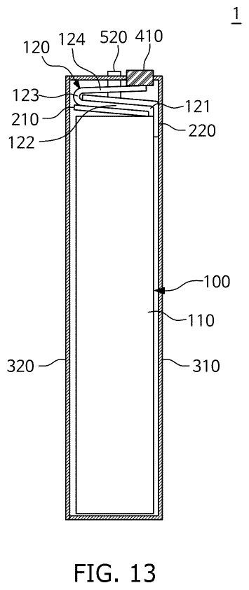

Referring to FIG. 13, in the attaching of the first insulating member 210 and the second insulating member 220 (e.g., at S200 and S300 of FIG. 14), the electrolyte injection ports 510 may be formed in the first insulating member 210 and the second insulating member 220. The electrolyte injection port 510 may be formed on one surface of the case 310 to correspond to the positions of the electrolyte injection ports 510 formed in the first insulating member 210 and the second insulating member 220. After the electrolyte is injected into the electrode assembly 100 through the electrolyte injection port 510, the sealing member 520 may seal the electrolyte injection port 510. The sealing member 520 may be a sealing pin, but the present disclosure is not limited thereto.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

1: secondary battery
100: electrode assembly
110: electrode stack
120: first electrode tab
130: second electrode tab
210: first insulating member
220: second insulating member
310: case
320: case cover
410: first electrode terminal
420: second electrode terminal
510: electrolyte injection port
520: sealing member

What is claimed is:

1. A secondary battery comprising:
an electrode assembly comprising an electrode stack comprising a first electrode, a separator, and a second electrode, and a first electrode tab and a second electrode tab protruding from a top surface of the electrode stack;
a first insulating member attached to the top surface of the electrode stack, a first surface of the first electrode tab, and a first surface of the second electrode tab;
a second insulating member attached to a rear surface of the electrode stack, a second surface of the first electrode tab, and a second surface of the second electrode tab;
a case having one opened surface, and configured to accommodate the electrode assembly; and
a case cover configured to cover the opened surface of the case to seal the electrode assembly from the outside.

2. The secondary battery as claimed in claim 1, wherein each of the first electrode tab and the second electrode tab comprises:
a first bent portion located in proximity to the top surface of the electrode stack; and
a first extension portion extending from the first bent portion.

3. The secondary battery as claimed in claim 2, wherein the first insulating member is located between the top surface of the electrode stack and the first extension portion of the first electrode tab, and between the top surface of the electrode stack and the first extension portion of the second electrode tab.

4. The secondary battery as claimed in claim 3, wherein each of the first electrode tab and the second electrode tab comprises:
a second extension portion extending from the first extension portion; and
a second bent portion located between the first extension portion and the second extension portion.

5. The secondary battery as claimed in claim 4, wherein the second insulating member is located between the case and the rear surface of the electrode stack, between the first extension portion of the first electrode tab and the second extension portion of the first electrode tab, and between the first extension portion of the second electrode tab and the second extension portion of the second electrode tab.

6. The secondary battery as claimed in claim 5, wherein the first insulating member is configured to insulate between the top surface of the electrode stack and one surface of the first electrode tab, and between the top surface of the electrode stack and one surface of the second electrode tab, and
wherein the second insulating member in configured to insulate between the case and the rear surface of the electrode stack, between the case and another surface of the first electrode tab, and between the case and another surface of the second electrode tab.

7. The secondary battery as claimed in claim 1, wherein each of the first insulating member and the second insulating member is continuously attached to cover the first electrode tab and the second electrode tab while extending in a direction from the first electrode tab to the second electrode tab on the top surface of the electrode stack.

8. The secondary battery as claimed in claim 1, further comprising:
a first electrode terminal penetrating through the case, and connected to the first electrode tab; and
a second electrode terminal spaced from the first electrode terminal, penetrating through the case, and connected to the second electrode tab.

9. The secondary battery as claimed in claim 1, wherein each of the first insulating member and the second insulating member comprises an electrolyte injection port.

10. The secondary battery as claimed in claim 9, further comprising a sealing member configured to seal the electrolyte injection port.

11. The secondary battery as claimed in claim 1, wherein each of the first insulating member and the second insulating member comprises an insulating tape.

12. The secondary battery as claimed in claim 1, wherein each of the first insulating member and the second insulating member comprises at least one of polyethylene terephthalate (PET), polypropylene (PP), or polyether ether ketone (PEEK).

13. A method of manufacturing a secondary battery, the method comprising:
forming an electrode assembly comprising an electrode stack comprising a first electrode, a separator, and a second electrode;
protruding a first electrode tab and a second electrode tab from a top surface of the electrode stack;
attaching a first insulating member to the top surface of the electrode stack, one surface of the first electrode tab, and one surface of the second electrode tab;
attaching a second insulating member to a rear surface of the electrode stack, another surface of the first electrode tab, and another surface of the second electrode tab;
accommodating the electrode assembly in a case having one opened surface, while bending the first electrode tab and the second electrode tab; and
covering the opened surface of the case with a case cover to seal the electrode assembly from the outside.

14. The method as claimed in claim 13, wherein the accommodating of the electrode assembly comprises:
firstly bending the first electrode tab and the second electrode tab downward in proximity to the top surface of the electrode stack;
secondly bending the first electrode tab and the second electrode tab upward to be connected to a first electrode terminal and a second electrode terminal formed to penetrate through the case;
connecting the first electrode tab and the second electrode tab to the first electrode terminal and the second electrode terminal, respectively; and
thirdly bending the first electrode tab and the second electrode tab to accommodate the electrode assembly in the case.

15. The method as claimed in claim 14, wherein the firstly bending comprises:
forming a first bending portion in each of the first electrode tab and the second electrode tab in proximity to the top surface of the electrode stack; and
disposing the first insulating member between the top surface of the electrode stack and a first extension portion extending from the first bending portion of each of the first electrode tab and the second electrode tab.

16. The method as claimed in claim 14, wherein the secondly bending comprises forming a second bent portion in each of the first electrode tab and the second electrode tab by bending the first electrode tab and the second electrode tab upward at one end where the first insulating member and the second insulating member are attached to the first electrode tab and the second electrode tab.

17. The method as claimed in claim 14, wherein the thirdly bending comprises disposing a second insulating member between a first extension portion extending from a first bent portion formed by firstly bending each of the first electrode tab and the second electrode tab and a second extension portion extending from a second bent portion formed by secondly bending each of the first electrode tab and the second electrode tab.

18. The method as claimed in claim 17, wherein the thirdly bending further comprises aligning the first electrode tab and the second electrode tab, so that the second bent portion of each of the first electrode tab and the second electrode tab is fixed by using a bending guide.

19. The method as claimed in claim 13, wherein the attaching of the first insulating member and the second insulating member comprises continuously attaching each of the first insulating member and the second insulating member to cover the first electrode tab and the second electrode tab in a direction from the first electrode tab to the second electrode tab on the top surface of the electrode stack.

20. The method as claimed in claim 13, further comprising:
forming an electrolyte injection port in each of the first insulating member and the second insulating member;
injecting an electrolyte into the electrolyte injection port; and
sealing the electrolyte injection port with a sealing member.
